(19) United States
(12) Patent Application Publication
(10) Pub. No.: US 2024/0169650 A1
(43) Pub. Date: May 23, 2024

(54) PARTICLE RENDERING METHOD AND APPARATUS

(71) Applicant: Beijing Zitiao Network Technology Co., Ltd., Beijing (CN)

(72) Inventors: Jinyuan WU, BEIJING (CN); Yi GUO, BEIJING (CN)

(21) Appl. No.: 18/551,321

(22) PCT Filed: Apr. 13, 2022
(86) PCT No.: PCT/CN2022/086561

§ 371 Date: Sep. 19, 2023

(30) Foreign Application Priority Data
May 31, 2021 (CN) 202110600412.9

(51) Int. Cl. G06T 15/00

(52) U.S. Cl. CPC G06T 15/005; G06T 2210/56

(57) ABSTRACT

The present disclosure discloses a particle rendering method and apparatus. The particle rendering method includes: obtaining a first coordinate value and a second coordinate value of an initial position of a particle, wherein the first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system; obtaining a first pseudo-random number corresponding to the first coordinate value and a second pseudo-random number corresponding to the second coordinate value based on a preset pseudo-random algorithm; obtaining a coordinate value of the particle on the first coordinate axis at a target motion time based on the first pseudo-random number, the second pseudo-random number and a first fitting algorithm; obtaining a coordinate value of the particle on the second coordinate axis at the target motion time based on the first pseudo-random number, the second pseudo-random number and a second fitting algorithm; and rendering the particle at the target motion time according to the coordinate value of the particle on the first coordinate axis and the coordinate value of the second coordinate is at the target motion time.

### CROSS-REFERENCE TO RELATED APPLICATIONS

This application is based on and claims the benefit of priority to the Chinese patent application No. 202110600412.9 filed on May 31, 2021, which is hereby incorporated by reference in its entirety into the present application.

### TECHNICAL FIELD

This disclosure relates to the field of image rendering technology, in particular to a particle rendering method and apparatus.

### BACKGROUND

Particle effect rendering in the field of image rendering refers to a special encapsulation of rendering effect capabilities. Specifically, a point set is created in 3D space, then each point in the point set is replaced with a particle model and rendered according to the properties of a specific material. Each point in the point set is called a particle. Particle effects are often used to create visual effects such as snowflakes, clouds, flames, raindrops, etc., and are widely used in the field of image rendering.

One of the bottlenecks in particle effect rendering is how to accurately simulate the motion trajectories of particles. In related technologies, with an initial position of each particle as a variable, a calculation is generally performed using a trajectory prediction algorithm to determine the motion trajectory of each particle.

### SUMMARY

In a first aspect, an embodiment of the present disclosure provides a particle rendering method, comprising:
obtaining a first coordinate value and a second coordinate value of an initial position of a particle, wherein the first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system;
obtaining a first pseudo-random number corresponding to the first coordinate value and a second pseudo-random number corresponding to the second coordinate value based on a preset pseudo-random algorithm;
obtaining a coordinate value of the particle on the first coordinate axis at a target motion time based on the first pseudo-random number, the second pseudo-random number and a first fitting algorithm;
obtaining a coordinate value of the particle on the second coordinate axis at the target motion time based on the first pseudo-random number, the second pseudo-random number and a second fitting algorithm; and
rendering the particle at the target motion time according to the coordinate value of the particle on the first coordinate axis and the coordinate value of the second coordinate axis at the target motion time.

As an optional embodiment of the present disclosure, the obtaining the first pseudo-random number corresponding to the first coordinate value and the second pseudo-random number corresponding to the second coordinate value based on the preset pseudo-random algorithm comprises:
obtaining a first calculation value and a second calculation value, wherein the first calculation value comprises an output value of a first function with a product of the first coordinate value and a first constant as an argument, and the second calculation value comprises an output value of the first function with a product of the second coordinate value and the first constant as an argument;
obtaining a third calculation value and a fourth calculation value, wherein the third calculation value comprises a product of the first calculation value and a second constant, and the fourth calculation value comprises a product of the second calculation value and the second constant;
obtaining a fractional part of the third calculation value as the first pseudo-random number; and
obtaining a fractional part of the fourth calculation value as the second pseudo-random number.

As an optional embodiment of the present disclosure, the first function comprises a sine function.

As an optional embodiment of the present disclosure, the obtaining the coordinate value of the particle on the first coordinate axis at the target motion time based on the first pseudo-random number, the second pseudo-random number and the first fitting algorithm comprises:
obtaining a fifth calculation value comprising an output value of a second function with a product of a third constant, the first pseudo-random number and the target motion time as an argument;
obtaining a sixth calculation value comprising a product of the fifth calculation value and a fourth constant;
obtaining a seventh calculation value comprising a product of a fifth constant, the second pseudo-random number and the target motion time;
obtaining an eighth calculation value comprising a sum of the seventh calculation value and a sixth constant;
obtaining a ninth calculation value comprising a product of a seventh constant and an output value of the second function with the eighth calculation value as an argument;
obtaining a tenth calculation value comprising a sum of the sixth calculation value and the ninth calculation value; and
obtaining a product of the tenth calculation value and an eighth constant as the coordinate value of the particle on the first coordinate axis at the target motion time.

As an optional embodiment of the present disclosure, obtaining a motion trajectory of the particle on the second coordinate axis based on the first pseudo-random number, the second pseudo-random number and a second fitting algorithm:
obtaining an eleventh calculation value comprising an output value of a second function with a product of a ninth constant, the second pseudo-random number and the target motion time as an argument;
obtaining a twelfth calculation value comprising a product of the eleventh calculation value and a tenth constant;
obtaining a thirteenth calculation value comprising a product of an eleventh constant, the first pseudo-random number and the target motion time;
obtaining a fourteenth calculation value comprising a sum of the thirteenth calculation value and a twelfth constant;
obtaining a fifteenth calculation value comprising an output value of the second function with the fourteenth calculation value as an argument;
obtaining a sixteenth calculation value comprising a sum of the twelfth calculation value and the fifteenth calculation value; and
obtaining a product of the sixteenth calculation value and a thirteenth constant as the coordinate value of the particle on the second coordinate axis corresponding to the target motion time.

As an optional embodiment of the present disclosure, the second function comprises a sine function.

As an optional embodiment of the present disclosure, the particle rendering method further comprises:
controlling the particle to return to the initial position and resetting a motion time of the particle to zero when the motion time of the particle reaches a duration threshold.

As an optional embodiment of the present disclosure, the particle rendering method further comprises:
obtaining coordinate values of the particle in a camera coordinate system at the target motion time based on the coordinate value of the particle on the first coordinate axis and the coordinate value of the particle on the second coordinate axis at the target motion time;
obtaining a target distance value based on the coordinate values of the particle in the camera coordinate system, the target distance value comprising a distance value from the particle to an origin of the camera coordinate system; and
determining a size of the particle based on the target distance value, wherein the particle size is negatively correlated with the target distance value.

As an optional embodiment of the present disclosure, the determining the size of the particle based on the target distance value comprises:
determining the size of the particle based on a ratio of a scaling factor to the target distance value.

In a second aspect, an embodiment of the present disclosure provides a particle rendering apparatus, comprising:
an initial coordinate obtaining unit for obtaining a first coordinate value and a second coordinate value of an initial position of a particle, wherein the first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system;
a pseudo-random number calculation unit for obtaining a first pseudo-random number corresponding to the first coordinate value and a second pseudo-random number corresponding to the second coordinate value based on a preset pseudo-random algorithm;
a first coordinate obtaining unit for obtaining a coordinate value of the particle on the first coordinate axis at a target motion time based on the first pseudo-random number, the second pseudo-random number and a first fitting algorithm;
a second coordinate obtaining unit for obtaining a coordinate value of the particle on the second coordinate axis at the target motion time based on the first pseudo-random number, the second pseudo-random number and a second fitting algorithm; and
a rendering unit for rendering the particle at the target motion time according to the coordinate value of the particle on the first coordinate axis and the coordinate value of the second coordinate axis at the target motion time.

As an optional embodiment of the present disclosure, the pseudo-random number calculation unit is particularly used for obtaining a first calculation value and a second calculation value, wherein the first calculation value comprises an output value of a first function with a product of the first coordinate value and a first constant as an argument, and the second calculation value comprises an output value of the first function with a product of the second coordinate value and the first constant as an argument; obtaining a third calculation value and a fourth calculation value, wherein the third calculation value comprises a product of the first calculation value and a second constant, and the fourth calculation value comprises a product of the second calculation value and the second constant; obtaining a fractional part of the third calculation value as the first pseudo-random number; and obtaining a fractional part of the fourth calculation value as the second pseudo-random number.

As an optional embodiment of the present disclosure, the first function comprises a sine function.

As an optional embodiment of the present disclosure, the first coordinate obtaining unit is particularly used for obtaining a fifth calculation value comprising an output value of a second function with a product of a third constant, the first pseudo-random number and the target motion time as an argument; obtaining a sixth calculation value comprising a product of the fifth calculation value and a fourth constant; obtaining a seventh calculation value comprising a product of a fifth constant, the second pseudo-random number and the target motion time; obtaining an eighth calculation value comprising a sum of the seventh calculation value and a sixth constant; obtaining a ninth calculation value comprising a product of a seventh constant and an output value of the second function with the eighth calculation value as an argument; obtaining a tenth calculation value comprising a sum of the sixth calculation value and the ninth calculation value; and obtaining a product of the tenth calculation value and an eighth constant as the coordinate value of the particle on the first coordinate axis at the target motion time.

As an optional embodiment of the present disclosure, the second coordinate obtaining unit is particularly used for obtaining an eleventh calculation value comprising an output value of a second function with a product of a ninth constant, the second pseudo-random number and the target motion time as an argument; obtaining a twelfth calculation value comprising a product of the eleventh calculation value and a tenth constant; obtaining a thirteenth calculation value comprising a product of an eleventh constant, the first pseudo-random number and the target motion time; obtaining a fourteenth calculation value comprising a sum of the thirteenth calculation value and a twelfth constant; obtaining a fifteenth calculation value comprising an output value of the second function with the fourteenth calculation value as an argument; obtaining a sixteenth calculation value comprising a sum of the twelfth calculation value and the fifteenth calculation value; and obtaining a product of the sixteenth calculation value and a thirteenth constant as the coordinate value of the particle on the second coordinate axis corresponding to the target motion time.

As an optional embodiment of the present disclosure, the second function comprises a sine function.

As an optional embodiment of the present disclosure, the particle rendering apparatus further comprises:
an initialization unit for controlling the particle to return to the initial position and resetting a motion time of the particle to zero when the motion time of the particle reaches a duration threshold.

As an optional embodiment of the present disclosure, the rendering unit is further used for obtaining coordinate values of the particle in a camera coordinate system at the target motion time based on the coordinate value of the particle on the first coordinate axis and the coordinate value of the particle on the second coordinate axis at the target motion time; obtaining a target distance value based on the coordinate values of the particle in the camera coordinate system, the target distance value comprising a distance value from the particle to an origin of the camera coordinate system; and determining a size of the particle based on the target distance value, wherein the particle size is negatively correlated with the target distance value.

As an optional embodiment of the present disclosure, the rendering unit is particularly used for determining the size of the particle based on a ratio of a scaling factor to the target distance value.

In a third aspect, an embodiment of the present disclosure provides an electronic device, comprising: a memory for storing a computer program; and a processor that, when executing the computer program, causes the electronic device to implement the particle rendering method according to any of the above embodiments.

In a fourth aspect, an embodiment of the present disclosure provides a non-transitory computer-readable storage medium stored thereon a computer program that, when executed by a computing device, causes the computing device to implement the particle rendering method according to any of the above embodiments.

In a fifth aspect, an embodiment of the present disclosure provides a computer program product that, when running on a computer, causes the computer to implement the particle rendering method according to any of the above embodiments.

In a sixth aspect, the present disclosure provides a computer program, comprising: instructions that, when executed by a processor, cause the processor to implement the particle rendering method according to any of the above embodiments.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present invention or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a flowchart of a particle rendering method provided in an embodiment of the present disclosure;

FIG. 2 is a schematic diagram of a particle rendering apparatus provided in an embodiment of the present disclosure;

FIG. 3 is another schematic diagram of the particle rendering apparatus provided in an embodiment of the present disclosure;

FIG. 4 is a schematic diagram showing the hardware structure of an electronic device provided in an embodiment of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

In the present disclosed embodiment, words such as “as an illustration” or “for example” are used to provide examples, illustrations, or explanations. Any embodiments or designs described with “as an illustration” or “for example” in the embodiments of the present disclosure should not be construed as being more preferred or advantageous than other embodiments or designs. In particular, the use of words such as “as an illustration” or “for example” is intended to present relevant concepts in a particular way. Moreover, in the description of the embodiments of the present disclosure, unless otherwise indicated, the phrase “a plurality of” means “two or more”.

Since the trajectory prediction algorithm used to calculate

the motion trajectory of each particle is the same trajectory prediction algorithm, and the initial positions of adjacent particles are very close, the motion trajectories of adjacent particles will be very similar. As a result, the calculated particle motion trajectories will differ greatly from the actual situations, making it difficult to accurately simulate the particle motion trajectories, resulting in poor particle rendering performance.

In view of this, an embodiment of the present disclosure provides a particle rendering method and apparatus for solving the problem of how to accurately simulate the motion trajectories of particles.

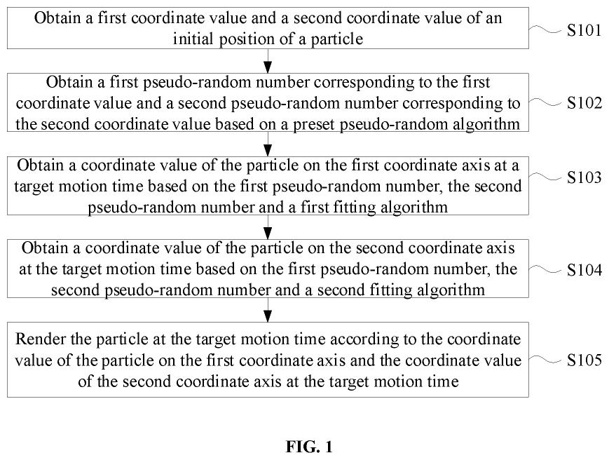

An embodiment of the present embodiment provides a particle rendering method. As shown in FIG. 1, the particle rendering method comprises the following steps.

In S101, a first coordinate value and a second coordinate value of an initial position of a particle are obtained.

The first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system.

Specifically, the local coordinate system in this embodiment refers to a coordinate system with a center of a rendered scene as its coordinate origin. The first coordinate axis may comprise an x-axis in the local coordinate system, and the second coordinate axis may comprise a z-axis in the local coordinate system.

In S102, a first pseudo-random number corresponding to the first coordinate value and a second pseudo-random number corresponding to the second coordinate value are obtained based on a preset pseudo-random algorithm.

The first pseudo-random number in this embodiment refers to a value calculated using the preset pseudo-random algorithm with the first coordinate value as a parameter, while the second pseudo-random number refers to a value calculated using the preset pseudo-random algorithm with the second coordinate value as a parameter. Since the same first or second coordinate value always results in a fixed first or second pseudo-random number, the first and second pseudo-random numbers obtained are not real random numbers. However, the first and second pseudo-random numbers have statistical properties similar to random numbers.

As an optional embodiment of the present disclosure, the above step S102 (obtaining a first pseudo-random number corresponding to the first coordinate value and a second pseudo-random number corresponding to the second coordinate value based on a preset pseudo-random algorithm) comprises the following steps a to d.

In step a, a first calculation value and a second calculation value are obtained.

The first calculation value comprises an output value of a first function with a product of the first coordinate value and a first constant as an argument, and the second calculation value comprises an output value of the first function with a product of the second coordinate value and the first constant as an argument.

Suppose that the first function is ƒ₁( ), the first coordinate value is xₚ, the second coordinate value is zₚ, the first constant is c₁, the first calculation value is A₁, and the second calculation value is B₁, then:

A₁=ƒ₁(xₚ*c₁)

B₁=ƒ₁(zₚ*c₁)

Optionally, the first function comprises a sine function.

That is, the first calculation value A₁=sin(xₚ*c₁), and the second calculation value B₁=sin(zₚ*c₁).

Optionally, on the basis of the above embodiment, the first function in the embodiments of the present disclosure may also be other trigonometric functions, such as a cosine function, a tangent function, etc. That is, the first function of the present disclosure comprises, but is not limited to, a sine function.

In step b, a third calculation value and a fourth calculation value are obtained.

The third calculation value comprises a product of the first calculation value and a second constant, and the fourth calculation value comprises a product of the second calculation value and the second constant.

Suppose that the second constant is c₂, the third calculation value is A₂, and the fourth calculation value is B₂, then:

A₂=A₁*c₂=ƒ₁(xₚ*c₁)*c₂

B₂=B₁*c₂=ƒ₁(zₚ*c₁)*c₂

It should be noted that the number of digits of the second constant can determine the statistical properties of the first and second pseudo-random numbers. In order to obtain the first and second pseudo-random numbers having statistical properties similar to real random numbers, the number of digits of the second constant can be set to a larger value. For example, the integral part of the second constant can have more than 5 digits, and its fractional part can have more than 8 digits.

In step c, a fractional part of the third calculation value is obtained as the first pseudo-random number.

Suppose that the first pseudo-random number is xᵣ, then:

xᵣ=fract(A₂)=fract[ƒ₁(xₚ*c₁)*c₂]

wherein fract( ) is a function that returns the fractional part of a number.

For example, fract(45815.551276)=0.551276.

In step d, a fractional part of the fourth calculation value is obtained as the second pseudo-random number.

Suppose that the second pseudo-random number is zᵣ, then:

zᵣ=fract(B₂)=fract[ƒ₁(zₚ*c₁)*c₂]

wherein fract( ) is a function that returns the fractional part of a number.

If the first function comprises a sine function, the calculation formula for the first and second pseudo-random numbers is as follows:

xᵣ=fract[sin(xₚ*c₁)*c₂]

zᵣ=fract[sin(zₚ*c₁)*c₂]

In S103, a coordinate value of the particle on the first coordinate axis at a target motion time is obtained based on the first pseudo-random number, the second pseudo-random number and a first fitting algorithm.

As an optional embodiment of the present disclosure, the above step S103 (obtaining a coordinate value of the particle on the first coordinate axis at a target motion time based on the first pseudo-random number, the second pseudo-random number and a first fitting algorithm) may comprise the following steps a1 to a7.

In step a1, a fifth calculation value is obtained.

The fifth calculation value is an output value of a second function with a product of a third constant, the first pseudo-random number and the target motion time as an argument.

Suppose that the second function is ƒ₂( ), the first pseudo-random number is xᵣ, the target motion time is T, the third constant is c₃, and the fifth calculation value is A₃, then:

A₃=ƒ₂(c₃*T*xᵣ)

Optionally, the second function comprises a sine function.

That is, the fifth calculation value A₃=sin(c₃*T*xᵣ).

Optionally, on the basis of the above embodiment, the second function in the embodiments of the present disclosure may also be other trigonometric functions, such as a cosine function, a tangent function, etc. That is, the second function of the present disclosure comprises, but is not limited to, a sine function.

In step a2, a sixth calculation value is obtained.

The sixth calculation value comprises a product of the fifth calculation value and a fourth constant.

Suppose that the sixth calculation value is A₄ and the fourth constant is c₄, then:

A₄=A₃*c₄=[ƒ₂(c₃*T*xᵣ)]*c₄

In step a3, a seventh calculation value is obtained.

The seventh calculation value comprises a product of a fifth constant, the second pseudo-random number and the target motion time.

Suppose that the seventh calculation value is A₅, the fifth constant is c₅, the second pseudo-random number is zᵣ, and the target motion time is T, then:

A₅=c₅*T*zᵣ

In step a4, an eighth calculation value is obtained.

The eighth calculation value comprises a sum of the seventh calculation value and a sixth constant.

Suppose that the eighth calculation value is A₆, the seventh calculation value is A₅, and the sixth constant is c₆, then:

A₆=A₅+c₆=c₅*T*zᵣ+c₆

In step a5, a ninth calculation value is obtained.

The ninth calculation value comprises a product of a seventh constant and an output value of the second function with the eighth calculation value as an argument.

Suppose that the ninth calculation value is A₇, the seventh constant is c₇, and the second function is ƒ₂( ), then:

A₇=ƒ₂(A₆)*c₇=[ƒ₂(c₅*T*zᵣ+c₆)]*c₇

Furthermore, if the second function comprises a sine function, then the ninth calculation value A₇=sin(c₅*T*zᵣ+c₆)*c₇.

In step a6, a tenth calculation value is obtained.

The tenth calculation value comprises a sum of the sixth calculation value and the ninth calculation value.

Suppose that the tenth calculation value is A₈, then:

A₈=A₄+A₇=[ƒ₂(c₃*T*xᵣ)]*c₄+[ƒ₂(c₅*T*zᵣ+c₆)]*c₇

In step a7, a product of the tenth calculation value and an eighth constant is obtained as the coordinate value of the particle on the first coordinate axis at the target motion time.

Suppose that the eighth constant is c₈, and the coordinate value of the particle on the first coordinate axis at the target motion time is x₊, then:

x₊=A₈*c₈={[ƒ₂(c₃*T*xᵣ)]*c₄+[ƒ₂(c₅*T*zᵣ+c₆)]}*c₈

Furthermore, if the second function comprises a sine function and the target motion time is T, the coordinate value of the particle on the first coordinate axis is:

x₊={[sin(c₃*T*xᵣ)]*c₄+[sin(c₅*T*zᵣ+c₆)]}*c₈

In S104, a coordinate value of the particle on the second coordinate axis at the target motion time is obtained based on the first pseudo-random number, the second pseudo-random number and a second fitting algorithm.

As an optional embodiment of the present disclosure, the above step S104 (obtaining a coordinate value of the particle on the second coordinate axis at the target motion time based on the first pseudo-random number, the second pseudo-random number and a second fitting algorithm) may comprise the following steps b1 to b7.

In step b1, an eleventh calculation value is obtained.

The eleventh calculation value comprises an output value of a second function with a product of a ninth constant, the second pseudo-random number and the target motion time as an argument.

Suppose that the second function is ƒ₂( ), the second pseudo-random number is zᵣ, the target motion time is T, the ninth constant is c₉, and the eleventh calculation value is B₃, then:

B₃=ƒ₂(c₉*T*zᵣ)

Optionally, the second function comprises a sine function.

That is, the eleventh calculation value B₃=sin(c₉*T*zᵣ).

In step b2, a twelfth calculation value is obtained.

The twelfth calculation value comprises a product of the eleventh calculation value and a tenth constant.

Suppose that the twelfth calculation value is B₄ and the tenth constant is c₁₀, then:

B₄=B₃*c₁₀=ƒ₂(c₉*T*zᵣ)*c₁₀

In step b3, a thirteenth calculation value is obtained.

The thirteenth calculation value comprises a product of an eleventh constant, the first pseudo-random number and the target motion time.

Suppose that the thirteenth calculation value is B₅, the eleventh constant is c₁₁, the first pseudo-random number is xᵣ, and the target motion time is T, then:

B₅=c₁₁*T*xᵣ

In step b4, a fourteenth calculation value is obtained.

The fourteenth calculation value comprises a sum of the thirteenth calculation value and a twelfth constant.

Suppose that the fourteenth calculation value is B₆, the thirteenth calculation value is B₅, and the twelfth constant is c₁₂, then:

B₆=B₅+c₁₂=c₁₁*T*xᵣ+c₁₂

In step b5, a fifteenth calculation value is obtained.

The fifteenth calculation value comprises an output value of the second function with the fourteenth calculation value as an argument.

Suppose that the fifteenth calculation value is B₇ and the second function is ƒ₂( ), then:

B₇=ƒ₂(B₆)=ƒ₂(c₁₁*T*xᵣ+c₁₂)

Furthermore, if the second function comprises a sine function, then the fifteenth calculation value B₇=sin(c₁₁*T*xᵣ+c₁₂).

In step b6, a sixteenth calculation value is obtained.

The sixteenth calculation value is a sum of the twelfth calculation value and the fifteenth calculation value.

Suppose that the sixteenth calculation value is B₈, then:

B₈=B₄+B₇=[ƒ₂(c₉*T*zᵣ)]*c₁₀+ƒ₂(c₁₁*T*xᵣ+c₁₂)

In step b7, a product of the sixteenth calculation value and a thirteenth constant is obtained as the coordinate value of the particle on the second coordinate axis corresponding to the target motion time.

Suppose that the thirteenth constant is c₁₃, and the coordinate value of the particle on the second coordinate axis at the target motion time T is z₊, then:

z₊=B₈*c₁₃={[ƒ₂(c₉*T*zᵣ)]*c₁₀+ƒ₂(c₁₁*T*xᵣ+c₁₂)}*c₁₃

Furthermore, if the second function comprises a sine function and the target motion time is T, the coordinate value of the particle on the second coordinate axis is:

z₊={[sin(c₉*T*zᵣ)]*c₁₀+sin(c₁₁*T*xᵣ+c₁₂)}*c₁₃

In S105, the particle at the target motion time is rendered according to the coordinate value of the particle on the first coordinate axis and the coordinate value of the second coordinate axis at the target motion time.

Specifically, the target motion time can be determined based on the output time of an image frame to be rendered, and then the coordinate value of the particle on the first coordinate axis at the target motion time and the coordinate value of the particle on the second coordinate axis at the target motion time can be determined based on the target motion time. Then, the position of the particle in the image frame is determined based on the coordinate values of the particle on the first coordinate axis and the second coordinate axis at the target motion time.

It should be noted that when determining the position of a particle in an image frame, in addition to obtaining the coordinate values of the particle on the first coordinate axis and the second coordinate axis, it is also necessary to determine the coordinate value of the particle in the vertical direction of the local coordinate system (for example, in a case where the first coordinate axis comprises the x-axis in the local coordinate system, and the second coordinate axis comprises the z-axis in the local coordinate system, the coordinate value in the vertical direction comprises the coordinate value on the y-axis of the local coordinate system). The method of obtaining the coordinate value of the particle in the vertical direction of the local coordinate system is not limited in this disclosed embodiment, as long as the coordinate value of the particle in the vertical direction of the local coordinate system can be obtained.

The particle rendering method provided in this embodiment of the present disclosure first obtains first and second coordinate values of an initial position of a particle on two coordinate axes mutually perpendicular within a horizontal plane in a local coordinate system, and then obtains a first pseudo-random number corresponding to the first coordinate value and a second pseudo-random number corresponding to the second coordinate value based on a preset pseudo-random algorithm. Then, a coordinate value of the particle on the first coordinate axis at a target motion time is obtained according to the first pseudo-random number, the second pseudo-random number and a first fitting algorithm, and a coordinate value of the particle on the second coordinate axis at the target motion time is obtained according to the first pseudo-random number, the second pseudo-random number and a second fitting algorithm. Then, the particle is rendered at the target motion time based on the coordinate values of the particle on the first coordinate axis and the second coordinate axis at the target motion time. In the embodiment of the present disclosure, after obtaining the first and second coordinate values of the initial position of the particle, the first pseudo-random number corresponding to the first coordinate value and the second pseudo-random number corresponding to the second coordinate value are obtained based on the preset pseudo-random algorithm, and then the positions of the particle at different motion times are obtained based on the first and second pseudo-random numbers. Therefore, the above embodiment can avoid the problem of motion trajectories of adjacent particles being too similar, and can accurately simulate the motion trajectories of the particles to obtain a more realistic particle rendering effect.

It should be noted that the constants (the first constant to the thirteenth constant) in the embodiment of the present disclosure can be specified according to particle types. The particle types may comprise, but are not limited to: snowflake, raindrop, smoke, willow catkin, dust, flame, etc.

As an optional embodiment of the present disclosure, based on the particle rendering method provided in the above embodiment, the particle rendering method provided in the embodiment of the present disclosure further comprises:
controlling the particle to return to the initial position and resetting a motion time of the particle to zero when the motion time of the particle reaches a duration threshold.

This means that the particle moves in the rendered scene with a certain period, periodically.

As an example, the duration threshold may be 1 minute; the particle is controlled to return to its initial position every 1 minute, resetting the particle's motion time to zero.

As an optional embodiment of the present disclosure, based on the particle rendering method provided in the above embodiment, the particle rendering method provided in the embodiment of the present disclosure further comprises the following steps I to III.

In step I, coordinate values of the particle in a camera coordinate system at the target motion time are obtained based on the coordinate value of the particle on the first coordinate axis and the coordinate value of the particle on the second coordinate axis at the target motion time.

Specifically, based on a conversion relationship between the local coordinate system and the camera coordinate system, the position coordinates of the particle in the local coordinate system can be converted into the position coordinates in the camera coordinate system, thereby obtaining the coordinate values of the particle in the camera coordinate system at the target motion time.

In step II, a target distance value is obtained based on the coordinate values of the particle in the camera coordinate system, the target distance value comprising a distance value from the particle to an origin of the camera coordinate system.

It should be noted that the origin of the camera coordinate system is the position where the camera is located, so the distance value from the particle to the origin of the camera coordinate system can be considered as the distance from the particle to the camera corresponding to the camera coordinate system.

In step III, a particle size is determined based on the target distance value.

The particle size is negatively correlated with the target distance value.

That is, the smaller the distance value between the particle and the origin of the camera coordinate system, the larger the particle size. Conversely, the larger the distance value between the particle and the origin of the camera coordinate system, the smaller the particle size.

Optionally, the determining the size of the particle based on the target distance value comprises:
determining the size of the particle based on a ratio of a scaling factor to the target distance value.

Suppose that the particle size is sₚ, the scaling factor is C, and the target distance value is d_{cp}, then:

sₚ=C/d_{cp}

In the above embodiment, coordinate values of the particle in the camera coordinate system are obtained, and a distance value of the particle from the origin of the camera coordinate system is obtained based on the coordinate values of the particle in the camera coordinate system, and then a particle size is determined based on the target distance value. Due to the negative correlation between the particle size and the target distance value, in the above embodiment, a particle has a larger size when it is closer to the camera and a smaller size when it is farther from the camera, thus achieving the effect of decreasing the particle size as the distance of the particle from the camera increases, making the particle rendering effect more realistic.

Based on the same inventive concept, as an implementation of the above method, a particle rendering apparatus is further provided in an embodiment of the present disclosure. This apparatus embodiment corresponds to the above method embodiment. For ease of reading, the contents of the above method embodiment will not be explained in detail in this apparatus embodiment, but it should be clarified that all the contents of the above method embodiment can be achieved correspondingly in this particle rendering apparatus.

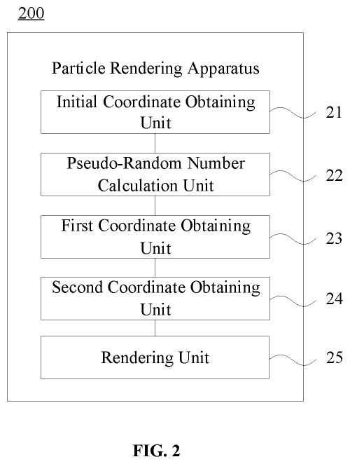

An embodiment of the present disclosure provides a particle rendering apparatus. FIG. 2 is a schematic structure diagram of the particle rendering apparatus. As shown in FIG. 2, the particle rendering apparatus 200 comprises:
an initial coordinate obtaining unit 21 for obtaining a first coordinate value and a second coordinate value of an initial position of a particle, wherein the first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system;
a pseudo-random number calculation unit 22 for obtaining a first pseudo-random number corresponding to the first coordinate value and a second pseudo-random number corresponding to the second coordinate value based on a preset pseudo-random algorithm;
a first coordinate obtaining unit 23 for obtaining a coordinate value of the particle on the first coordinate axis at a target motion time based on the first pseudo-random number, the second pseudo-random number and a first fitting algorithm;
a second coordinate obtaining unit 24 for obtaining a coordinate value of the particle on the second coordinate axis at the target motion time based on the first pseudo-random number, the second pseudo-random number and a second fitting algorithm; and
a rendering unit 25 for rendering the particle at the target motion time according to the coordinate value of the particle on the first coordinate axis and the coordinate value of the second coordinate axis at the target motion time.

As an optional embodiment of the present disclosure, the pseudo-random number calculation unit 22 is particularly used for obtaining a first calculation value and a second calculation value, wherein the first calculation value comprises an output value of a first function with a product of the first coordinate value and a first constant as an argument, and the second calculation value comprises an output value of the first function with a product of the second coordinate value and the first constant as an argument; obtaining a third calculation value and a fourth calculation value, wherein the third calculation value comprises a product of the first calculation value and a second constant, and the fourth calculation value comprises a product of the second calculation value and the second constant; obtaining a fractional part of the third calculation value as the first pseudo-random number; and obtaining a fractional part of the fourth calculation value as the second pseudo-random number.

As an optional embodiment of the present disclosure, the first function comprises a sine function.

As an optional embodiment of the present disclosure, the first coordinate obtaining unit 23 is particularly used for obtaining a fifth calculation value comprising an output value of a second function with a product of a third constant, the first pseudo-random number and the target motion time as an argument; obtaining a sixth calculation value comprising a product of the fifth calculation value and a fourth constant; obtaining a seventh calculation value comprising a product of a fifth constant, the second pseudo-random number and the target motion time; obtaining an eighth calculation value comprising a sum of the seventh calculation value and a sixth constant; obtaining a ninth calculation value comprising a product of a seventh constant and an output value of the second function with the eighth calculation value as an argument; obtaining a tenth calculation value comprising a sum of the sixth calculation value and the ninth calculation value; and obtaining a product of the tenth calculation value and an eighth constant as the coordinate value of the particle on the first coordinate axis at the target motion time.

As an optional embodiment of the present disclosure, the second coordinate obtaining unit 24 is particularly used for obtaining an eleventh calculation value comprising an output value of a second function with a product of a ninth constant, the second pseudo-random number and the target motion time as an argument; obtaining a twelfth calculation value comprising a product of the eleventh calculation value and a tenth constant; obtaining a thirteenth calculation value comprising a product of an eleventh constant, the first pseudo-random number and the target motion time; obtaining a fourteenth calculation value comprising a sum of the thirteenth calculation value and a twelfth constant; obtaining a fifteenth calculation value comprising an output value of the second function with the fourteenth calculation value as an argument; obtaining a sixteenth calculation value comprising a sum of the twelfth calculation value and the fifteenth calculation value; and obtaining a product of the sixteenth calculation value and a thirteenth constant as the coordinate value of the particle on the second coordinate axis corresponding to the target motion time.

As an optional embodiment of the present disclosure, the second function comprises a sine function.

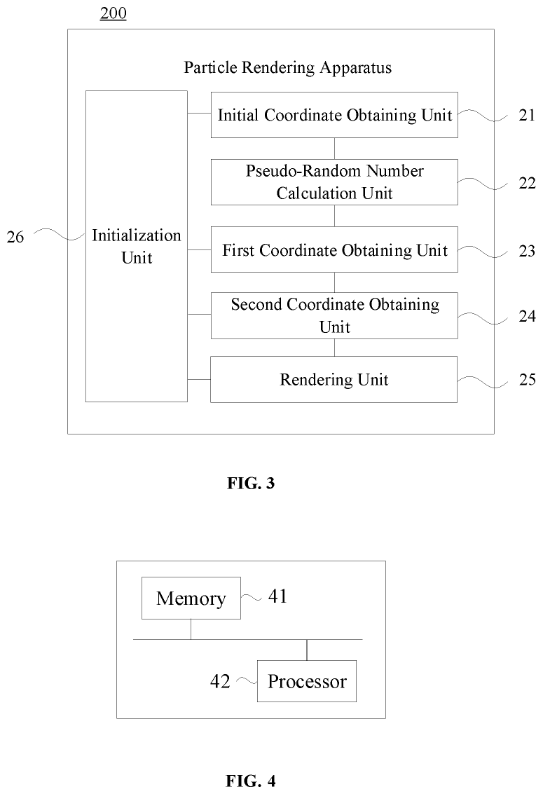

As an optional embodiment of the present disclosure, as shown in FIG. 3, the particle rendering apparatus 200 further comprises:
an initialization unit 26 for controlling the particle to return to the initial position and resetting a motion time of the particle to zero when the motion time of the particle reaches a duration threshold.

As an optional embodiment of the present disclosure, the rendering unit 25 is further used for obtaining coordinate values of the particle in a camera coordinate system at the target motion time based on the coordinate value of the particle on the first coordinate axis and the coordinate value of the particle on the second coordinate axis at the target motion time; obtaining a target distance value based on the coordinate values of the particle in the camera coordinate system, the target distance value comprising a distance value from the particle to an origin of the camera coordinate system; and determining a size of the particle based on the target distance value, wherein the particle size is negatively correlated with the target distance value.

As an optional embodiment of the present disclosure, the rendering unit 25 is particularly used for determining the size of the particle based on a ratio of a scaling factor to the target distance value.

The particle rendering apparatus provided in this embodiment can perform the particle rendering method provided in the above method embodiment, and its principle and technical effect are similar to that of the method embodiment, which will not be repeated here.

Based on the same inventive concept, an embodiment of the present disclosure further provides an electronic device. FIG. 4 is a schematic diagram showing the structure of the electronic device provided in an embodiment of the present disclosure. As shown in FIG. 4. the electronic device provided in this embodiment comprises: a memory 41 for storing a computer program; and a processor 42 that, when executing the computer program, causes the electronic device to implement the particle rendering method according to any of the above embodiments.

An embodiment of the present disclosure further provides a computer-readable storage medium stored thereon a computer program that, when executed by a computing device, causes the computing device to implement the particle rendering method according to any of the above embodiments.

An embodiment of the present disclosure further provides a computer program product that, when running on a computer, causes the computer to implement the particle rendering method according to any of the above embodiments.

One skilled in the art should understand that, the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable storage media having computer-usable program code embodied therein.

The processors may be central processing units (CPUs) or other general-purpose processors, digital signal processors (DSPs), application specific integrated circuits (ASICs), field programmable gate arrays (FPGAs) or other programmable logic devices, or discrete hardware components such as discrete gates or transistors. The general -purpose processor may be a microprocessor, or the processor may be any conventional processor or the like.

The memory may include non-permanent memory in a computer-readable medium, random access memory (RAM) and/or non-volatile memory, such as read only memory (ROM) or flash RAM. The memory is an example of a computer-readable medium.

The computer-readable media include permanent and non-permanent, removable and non-removable storage media. The storage medium can realize information storage by any method or technology. The information can be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassettes, magnetic tape, magnetic disk storage or other magnetic storage devices, or any other non-transmission media that can be used to store information that can be accessed by computing devices. According to the definition herein, computer-readable media does not include transitory media, such as modulated data signals and carrier waves.

It shall be noted that: the above embodiments are merely illustration of the technical solution of this disclosure, but are not limitation thereof. Although this disclosure has been described in detail with reference to the above embodiment, those ordinary skilled in the art shall understand: the technical solutions recited in the various embodiments described above may be modified or some technical features thereof or all the technical features may be substituted equivalently, such modifications or substitutions do not deviate the nature of the technique from the scope of the technique embodied in the embodiments according to this disclosure.

1. A particle rendering method, comprising:
obtaining a first coordinate value and a second coordinate value of an initial position of a particle, wherein the first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system;
obtaining a first pseudo-random number corresponding to the first coordinate value and a second pseudo-random number corresponding to the second coordinate value based on a preset pseudo-random algorithm;
obtaining a coordinate value of the particle on the first coordinate axis at a target motion time based on the first pseudo-random number, the second pseudo-random number and a first fitting algorithm;
obtaining a coordinate value of the particle on the second coordinate axis at the target motion time based on the first pseudo-random number, the second pseudo-random number and a second fitting algorithm; and
rendering the particle at the target motion time according to the coordinate value of the particle on the first coordinate axis and the coordinate value of the second coordinate axis at the target motion time.

2. The particle rendering method according to claim 1, wherein the obtaining the first pseudo-random number corresponding to the first coordinate value and the second pseudo-random number corresponding to the second coordinate value based on the preset pseudo-random algorithm comprises:
obtaining a first calculation value and a second calculation value, wherein the first calculation value comprises an output value of a first function with a product of the first coordinate value and a first constant as an argument, and the second calculation value comprises an output value of the first function with a product of the second coordinate value and the first constant as an argument;
obtaining a third calculation value and a fourth calculation value, wherein the third calculation value comprises a product of the first calculation value and a second constant, and the fourth calculation value comprises a product of the second calculation value and the second constant;
obtaining a fractional part of the third calculation value as the first pseudo-random number; and
obtaining a fractional part of the fourth calculation value as the second pseudo-random number.

3. The particle rendering method according to claim 2, wherein the first function comprises a sine function.

4. The particle rendering method according to claim 1, wherein the obtaining the coordinate value of the particle on the first coordinate axis at the target motion time based on the first pseudo-random number, the second pseudo-random number and the first fitting algorithm comprises:
obtaining a fifth calculation value comprising an output value of a second function with a product of a third constant, the first pseudo-random number and the target motion time as an argument;
obtaining a sixth calculation value comprising a product of the fifth calculation value and a fourth constant;
obtaining a seventh calculation value comprising a product of a fifth constant, the second pseudo-random number and the target motion time;
obtaining an eighth calculation value comprising a sum of the seventh calculation value and a sixth constant;
obtaining a ninth calculation value comprising a product of a seventh constant and an output value of the second function with the eighth calculation value as an argument;
obtaining a tenth calculation value comprising a sum of the sixth calculation value and the ninth calculation value; and
obtaining a product of the tenth calculation value and an eighth constant as the coordinate value of the particle on the first coordinate axis at the target motion time.

5. The particle rendering method according to claim 1, wherein the obtaining the coordinate value of the particle on the second coordinate axis at the target motion time based on the first pseudo-random number, the second pseudo-random number and a second fitting algorithm:
obtaining an eleventh calculation value comprising an output value of a second function with a product of a ninth constant, the second pseudo-random number and the target motion time as an argument;
obtaining a twelfth calculation value comprising a product of the eleventh calculation value and a tenth constant;
obtaining a thirteenth calculation value comprising a product of an eleventh constant, the first pseudo-random number and the target motion time;
obtaining a fourteenth calculation value comprising a sum of the thirteenth calculation value and a twelfth constant;
obtaining a fifteenth calculation value comprising an output value of the second function with the fourteenth calculation value as an argument;
obtaining a sixteenth calculation value comprising a sum of the twelfth calculation value and the fifteenth calculation value; and
obtaining a product of the sixteenth calculation value and a thirteenth constant as the coordinate value of the particle on the second coordinate axis corresponding to the target motion time.

6. The particle rendering method according to claim 4, wherein the second function comprises a sine function.

7. The particle rendering method according to claim 1, further comprising:
controlling the particle to return to the initial position and resetting a motion time of the particle to zero when the motion time of the particle reaches a duration threshold.

8. The particle rendering method according to claim 1, further comprising:
obtaining coordinate values of the particle in a camera coordinate system at the target motion time based on the coordinate value of the particle on the first coordinate axis and the coordinate value of the particle on the second coordinate axis at the target motion time;
obtaining a target distance value based on the coordinate values of the particle in the camera coordinate system, the target distance value comprising a distance value from the particle to an origin of the camera coordinate system; and
determining a size of the particle based on the target distance value, wherein the particle size is negatively correlated with the target distance value.

9. The particle rendering method according to claim 8, wherein the determining the size of the particle based on the target distance value comprises:
determining the size of the particle based on a ratio of a scaling factor to the target distance value.

10. (canceled)

11. An electronic device, comprising:
a memory for storing a computer program; and
a processor that, when executing the computer program, causes the electronic device to implement a particle rendering method comprising:
obtaining a first coordinate value and a second coordinate value of an initial position of a particle, wherein the first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system;
obtaining a first pseudo-random number corresponding to the first coordinate value and a second pseudo-random number corresponding to the second coordinate value based on a preset pseudo-random algorithm;
obtaining a coordinate value of the particle on the first coordinate axis at a target motion time based on the first pseudo-random number, the second pseudo-random number and a first fitting algorithm;
obtaining a coordinate value of the particle on the second coordinate axis at the target motion time based on the first pseudo-random number, the second pseudo-random number and a second fitting algorithm; and
rendering the particle at the target motion time according to the coordinate value of the particle on the first coordinate axis and the coordinate value of the second coordinate axis at the target motion time.

12. A non-transitory computer-readable storage medium stored thereon a computer program that, when executed by a computing device, causes the computing device to implement a particle rendering method comprising:
obtaining a first coordinate value and a second coordinate value of an initial position of a particle, wherein the first coordinate value is a coordinate value of the particle on a first coordinate axis, and the second coordinate value is a coordinate value of the particle on a second coordinate axis, the first coordinate axis and the second coordinate axis being two coordinate axes mutually perpendicular within a horizontal plane in a local coordinate system;
obtaining a first pseudo-random number corresponding to the first coordinate value and a second pseudo-random number corresponding to the second coordinate value based on a preset pseudo-random algorithm;
obtaining a coordinate value of the particle on the first coordinate axis at a target motion time based on the first pseudo-random number, the second pseudo-random number and a first fitting algorithm;
obtaining a coordinate value of the particle on the second coordinate axis at the target motion time based on the first pseudo-random number, the second pseudo-random number and a second fitting algorithm; and
rendering the particle at the target motion time according to the coordinate value of the particle on the first coordinate axis and the coordinate value of the second coordinate axis at the target motion time.

13. (canceled)

14. (canceled)

15. The particle rendering method according to claim 5, wherein the second function comprises a sine function.

16. The electronic device according to claim 11, wherein the processor is configured to:
obtain a first calculation value and a second calculation value, wherein the first calculation value comprises an output value of a first function with a product of the first coordinate value and a first constant as an argument, and the second calculation value comprises an output value of the first function with a product of the second coordinate value and the first constant as an argument;
obtain a third calculation value and a fourth calculation value, wherein the third calculation value comprises a product of the first calculation value and a second constant, and the fourth calculation value comprises a product of the second calculation value and the second constant;
obtain a fractional part of the third calculation value as the first pseudo-random number; and
obtain a fractional part of the fourth calculation value as the second pseudo-random number.

17. The electronic device according to claim 16, wherein the first function comprises a sine function.

18. The electronic device according to claim 11, wherein the processor is configured to:
obtain a fifth calculation value comprising an output value of a second function with a product of a third constant, the first pseudo-random number and the target motion time as an argument;
obtaining a sixth calculation value comprising a product of the fifth calculation value and a fourth constant;
obtain a seventh calculation value comprising a product of a fifth constant, the second pseudo-random number and the target motion time;
obtain an eighth calculation value comprising a sum of the seventh calculation value and a sixth constant;
obtain a ninth calculation value comprising a product of a seventh constant and an output value of the second function with the eighth calculation value as an argument;
obtain a tenth calculation value comprising a sum of the sixth calculation value and the ninth calculation value; and
obtain a product of the tenth calculation value and an eighth constant as the coordinate value of the particle on the first coordinate axis at the target motion time.

19. The electronic device according to claim 11, wherein the processor is configured to:
obtain an eleventh calculation value comprising an output value of a second function with a product of a ninth constant, the second pseudo-random number and the target motion time as an argument;
obtain a twelfth calculation value comprising a product of the eleventh calculation value and a tenth constant;
obtain a thirteenth calculation value comprising a product of an eleventh constant, the first pseudo-random number and the target motion time;
obtain a fourteenth calculation value comprising a sum of the thirteenth calculation value and a twelfth constant;
obtain a fifteenth calculation value comprising an output value of the second function with the fourteenth calculation value as an argument;
obtain a sixteenth calculation value comprising a sum of the twelfth calculation value and the fifteenth calculation value; and
obtain a product of the sixteenth calculation value and a thirteenth constant as the coordinate value of the particle on the second coordinate axis corresponding to the target motion time.

20. The electronic device according to claim 18, wherein the second function comprises a sine function.

21. The electronic device according to claim 19, wherein the second function comprises a sine function.

22. The electronic device according to claim 11, the processor is configured to control the particle to return to the initial position and resetting a motion time of the particle to zero when the motion time of the particle reaches a duration threshold.

23. The electronic device according to claim 11, the processor is configured to:
obtain coordinate values of the particle in a camera coordinate system at the target motion time based on the coordinate value of the particle on the first coordinate axis and the coordinate value of the particle on the second coordinate axis at the target motion time;
obtain a target distance value based on the coordinate values of the particle in the camera coordinate system, the target distance value comprising a distance value from the particle to an origin of the camera coordinate system; and
determine a size of the particle based on the target distance value, wherein the particle size is negatively correlated with the target distance value.
